(19) United States
(12) Patent Application Publication
(10) Pub. No.: US 2006/0003070 A1
(43) Pub. Date: Jan. 5, 2006

(54) Low carbohydrate flour substitute

(76) Inventor: Harold Toy Muller-Thym JR., Darlington, MD (US)

Correspondence Address: SMITH, GAMBRELL & RUSSELL, LLP, 1230 PEACHTREE STREET, N.E., SUITE 3100, PROMENADE II, ATLANTA, GA, 30309-3592, US

(21) Appl. No.: 10/881,931

(22) Filed: Jun. 30, 2004

(51) Int. Cl. A21D 10/00

(52) U.S. Cl. 426/549

(57) ABSTRACT

A low carbohydrate flour substitute for making food product having the mouth feel of a typical grain product with minimal carbohydrate content comprises in combination hydrogenated starch hydrolysate, vegetable protein, and fibers having a length determined to provide the desired mouth feel. High intensity sweetners, albumin, and other additives are added in appropriate amounts which provide taste, texture, and coloration.

The present invention relates to a low carbohydrate flour substitute for producing low carbohydrate and low calorie grain based products (such as breads and pastas and the like) for use in standard and special diets designed to limit and control the intake of digestible carbohydrates, as well as to methods for making such grain based products.

### BACKGROUND OF THE INVENTION

The high blood glucose levels and high blood insulin levels associated with excessive consumption of digestible carbohydrates can lead to general health concerns including diabetes. Eating three high carbohydrate meals a day plus snacks and beverages rich in carbohydrates can elevate glucose and insulin levels for upwards of 16 hours per day. High levels of insulin can lead to excessive deposits of adipose fat, resulting in obesity. Obesity is a cause of many health problems including cardiac disease. High blood insulin levels can lead to blindness, poor circulation, high blood pressure, kidney failure, heart disease, stroke, and deterioration particularly of the peripheral nerves of the feet and legs. Diabetes is the leading cause of blindness and kidney failure. It quadruples the risk of heart disease and is responsible for over 90,000 amputations per year in the U.S. Diabetes is the seventh leading cause of death in America.

The main sources of carbohydrates in grain based products are sugar and flour. However, in contrast to the problems associated with high carbohydrate diets, sugar and flour also provide many beneficial properties to grain based products. For example, sugar supplies sweetness, browning, and bulking. In addition, flour provides structure and bulking and plays an important function in the mouth feel of the resulting grain based product.

In the past, attempts have been made to produce low carbohydrate bread products by using substitute ingredients to replace the sugar component. However, many of the substitute sweeteners, such as polydextrose or inulin, used in the past have yielded baked products that were bitter to the taste. The substitute sweeteners have also proven to be unstable when exposed to heat. In addition, many of the sugar substitutes have the disadvantage of activating the colon causing cramping, gas, and diarrhea.

Prior attempts to reduce the carbohydrate levels in bread products have also focused on reducing the amount of flour used in making the bread product. In these reduced flour bread products, the flour reduction was accomplished by replacing a portion of the total flour content with a flour substitute. However, these products, wherein a portion of the flour replaced, have also been less than acceptable in that the mouth feel of the resulting baked bread product was unpalatable and thus unacceptable. Moreover, because only part of the flour is replaced, the products still have a undesirably high concentration of carbohydrates.

Thus, while others have produced bread products having reduced levels of carbohydrates for dietary and nutritional purposes, there remains a need to develop grain based product formulations which contain a minimal amount of flour, and preferably no flour, as well as a minimal amount of sugar. Thus, the present invention provides a grain based product having low carbohydrate levels and preferably also low calorie, salt and oil levels while also having an acceptable mouth feel.

It should also be noted that the present invention reduces the amount of time and labor required to produce certain grain food products. For example, conventional bread has to be proofed to allow the yeast component to work, thus requiring time, storage and handling during this step. The present invention requires no proofing and thus facilitates production of bread products in a more efficient manner.

### DETAILED DESCRIPTION OF THE INVENTION

The present invention relates to a composition that can be used as a flour substitute for making food products such as baked goods. For example, the flour substitute composition of the present invention is useful for replacing all or a portion of the flour used to make a grain based product, including breads, rolls, muffins, cakes, pastries, pies, pancakes, waffles, crepes, crackers, pastas, tortillas, cereal etc., to thereby produce a grain based product that is low in carbohydrates and calories. In addition, the flour substitute of the present invention is also useful for producing a grain based product that is not only low in carbohydrates but is also low in oil and salt, and preferably contains no salt or oil. Furthermore, the products produced by employing the flour substitute composition of the present invention can also be formulated to be low in sugar, and preferably sugar free.

Since flour is made from protein and starch, finding a composition that can replace the entire amount of flour used to make given food product has proven to be challenging. However, the present inventors have found that the protein fraction of wheat flour can be replaced with vegetable protein, and preferably straight wheat protein, commonly called vital wheat gluten. Wheat gluten is protein derived from wheat which has had the starch washed out prior to drying. This protein provides strength and volume during and after baking, and holds in gases thus making the products rise.

Replacing the starch portion of the flour is accomplished using fiber. The fiber comes in various lengths, but the present inventors have found that the best mouth feel comes from soy fiber, sugar cane fiber, and cottonseed fiber. These fibers were chosen due to their fiber length which effects the mouth feel of the resulting food product, and their ability to not produce colon gas. Each of these fibers have been tested and found to be adequate replacements for the starch portion of flour. The fiber particles can be up to 350 microns in length and are preferably between about 10 to 350 microns in length, more preferably between about 20 to 120 microns, and more preferably about 30 to 80 microns. Moreover, preferred fiber lengths are as follows. For soy fiber, the preferred length is approximately 30 microns. For both the Sugar Cane and Cottonseed fibers, the preferred fiber length is 80 microns. While longer fibers are also acceptable, smaller fibers are preferred and provide a better mouth feel in the resulting product.

Since, the fibers used in the present invention come from grain or vegetable sources, they contain virtually no starch which is a main source of carbohydrates in many food products. While the fibers might contain a minimal amount of starch or sugar, the starch or sugar is naturally occurring rather than introduced by the process. Moreover, these traces of naturally occurring starch add virtually no detectable carbohydrate to the final product.

Most bakery products have an absorption rate of 50 to 65 percent based on flour. Moreover, during testing of the various fiber and protein combinations for use as a flour substitute, it was found that combining fiber and protein alone yielded an unsatisfactory product. This is because the resulting blend was too dry and non-cohesive. The fibers tend to grab and hang on to large volumes of water. Consequently, the flour substitute of the present invention has an absorption rate that is generally higher than similar products made with flour. For example, cakes made with the flour substitute of the present invention has and absorption rate of 80% whereas such a cake when made with flour would typically have an absorption rate of 35-45%. Hence, food products made with the flour substitute have to be handled like a cake batter before they are baked. In addition, the omission of salt and oils makes the batter sticky and the proteins sensitive to abuse. For example, over mixing will cause the proteins to break down, not allowing the product to rise during baking.

Without wishing to be bound by any theory, the inventor's believe that proteins need some sort of bulking agent to keep the proteins apart, allowing them to become fully hydrated. Hence, a stabilizer, such as hydrogenated starch hydrolysates, serves the function of a bulking agent. Hydrogenated starch hydrolysates resemble sugar in baking but without the sweetness. Hydrogenated starch hydrolysates, which are much less expensive than other bulking products, act like hard starch particles. Examples of hydrogenated starch hydrolysates include stabilite SD 30 and stabilite SD60, both available from SPI Polyols, stablilite SD30 being preferred. Sugar alcohols would also serve as an acceptable bulking agent. However, sugar alcohols are costly.

Additional ingredients which can be used with the flour substitute of the present invention to make grain based products include sugar substitutes. The use of sugar in baking is known to have many benefits. For example, sugar supplies sweetness, browning, and bulking. Sugar surrounds the protein allowing the protein to slide. Sugar also helps reduce the stickiness of the proteins used to make food products. However, sugar adds a high amount of calories to food. Thus, to reduce the calories associated with sugar, a high intensity sweetener with a bulking fiber can be used to replace sugar. Suitable bulking replacers include polydextrose, sugar alcohols, or fiber. Unfortunately, these sugar substitutes have a big disadvantage, in that they activate the colon causing cramping, gas, and diarrhea. Fortunately, not all have the same activation level. The sugar free products of the present invention employ a sugar substitute that has minimal to no colon effects.

One group of sugar substitutes includes high intensity artificial sweeteners. These high intensity sweeteners also have their own set of problems. Not all are heat stable causing the product to be sweet in the bowl before being baked but bitter after going through the oven. The sweeteners used in the products of the present invention are approved by the Food and Drug Administration (FDA), for example Neotame® (N-[N-(3,3-dimethylbutyl)-L-α-aspartyl]-L-phenylalanine 1-methyl ester). These sweeteners carry no warnings on labels and are stable through heat applications.

Furthermore, still other ingredients which can be combined with the flour substitute include albumin or egg protein, milk protein, leavening agents, hydrocolloid systems, and dough conditioner/softeners, such as mono- and di-glycerides of edible fats or oils or edible fat forming acids. Albumin, for example egg whites, provide protein and flavor, and produce a synergistic effect with the wheat protein. Egg whites also help remove the fiber taste. In addition, milk protein, such as sweet dairy whey or butter milk solids, also provides protein and flavor and is relatively inexpensive. Whey also adds color and flavor to the finished product.

Preferred leavening agents include sodium bicarbonate, which is a source of carbon dioxide (gas) combined with sodium aluminum phosphate, which is an acid and releases the carbon dioxide in sodium bicarbonate. While sodium bicarbonate combined with sodium aluminum phosphate is a preferred leavening system, any chemically leavening system can be used. The sodium bicarbonate/sodium aluminum phosphate combination is merely a example and was chosen to minimize the possibility of experiencing phosphate burn in the mouth and to keep off flavors to a minimum. Hydrocolloid systems/thickening agents, for example include guar gum and CMC gum, are used to help to control water within the grain based product, for example in muffins, and to help with viscosity. CMC is fast acting while Guar gum is slower.

Because the food products of the present invention can be made without yeast, proofing is not necessary. Moreover, the resulting mixtures can be deposited in a greased pan and directly deposited into the oven. To obtain maximum baked volume for example, in baking breads and rolls the top of the unbaked mixture is preferably sprayed or coated with a product such a Lite Glaze, which holds in gases to thereby increase the volume of the bread.

The following Table shows acceptable ingredient percentage ranges by weight in the composition before addition of water, which can be used to make grain based products employing the flour substitute of the present invention. Modifying the percentages shown below will allow the provision of various grain food products such as breads, rolls, muffins, cakes, pastries, pies, pancakes, waffles, crepes, crackers, pastas, tortillas, and cereal.

TABLE 1
Ingredient Ranges

| | Usable Range | Usable Range | Preferred Range |
|---|---|---|---|
| Hydrogenate Starch | 15.0% | 70.0% | 25-35% |
| Hydrolysates | | | |
| Fiber | 10.0% | 60.0% | 20-30% |
| Vegetable Protein | 5.0% | 50.0% | 15-25% |
| Egg Whites | 3.0% | 20.0% | 5-15% |
| Milk Protein | 0.0% | 10.0% | <10.0% |
| Sodium Bicarbonate | 0.0% | 7.0% | <7.0% |
| Sodium Aluminum | 0.5% | 7.0% | <7.0% |
| Phosphate | | | |
| Dough Conditioners | 0.5% | 3.0% | <3.0% |
| Guar Gum | 0.0% | 2.0% | <2.0% |
| CMC | 0.0% | 2.0% | <1.0% |
| Neotame ® | 0.0% | 1.0% | <1.0% |

Preferably, the above ingredients are present in the following amounts. Hydrogentate Starch Hydrolysates about 30.0%; Fiber about 25.0%; Vegetable Protein about 20.0%; Egg Whites about 10.0%; Milk Protein about 5.0%; Soda about 3.7%; Sodium Aluminum Phosphate about 3.7%; Dough Conditioner about 1.0%; Guar Gum about 0.8%; CMC about 0.796%; and Neotame® about 0.004%.

The present invention is readily scalable to be mass produced. To mass produce a grain based product employing the flour and sugar substitute compositions of the present invention, those of ordinary skill would scale the ingredients and blend. For example, a fifty-pound quantity of the composition would be scaled into the bowl and forty pounds of cold water added. The combined ingredients are then mixed at low speed for 4 to 5 minutes only to keep the development on the under mixed side. The mixing times would be varied based on equipment types. However, care should be taken not to over mix because, with no salt in the formula, the protein will break down quickly if mixed too much or for too long. Moreover, any bakery mixer should work. After mixing, the mixture is placed or poured into a suitable baking container and placed directly into the oven without proofing. The resulting baked product would then be packaged in acceptable freshness and preservative containers.

Determining the appropriate bake time is within the level of skill in the art. For example bake times of 25 to 30 minutes at temperatures of 300 to 350° were found to be adequate. Baking at too high of a temperature will cause the fibers on the outside to seal over causing the volume to be less. Breads need more oven time and higher temperatures. Floor times should not play an important role, except in the summer when plant temperatures are up. Higher temperatures will cause a preliminary firing of the gases in the mix causing lesser volume. The ingredients used to make the composition of the present invention are preferably stored in a cool dry environment in accordance with good manufacturing practices. Moreover, ingredients are readily transportable in acceptable vehicles.

It should be emphasized that the above-described embodiments of the present invention, particularly, and “preferred” embodiments, are merely examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of the disclosure and the present invention and protected by the following claims.

1. A composition to be used as a flour substitute comprising between about 15% to 70% by weight bulking agent which acts like hard starch particles, between about 10% to 60% by weight fiber, between about 5% to 50% by weight vegetable protein, and between about 3% to 20% by weight egg whites.

2. The composition as defined in claim 1 wherein said bulking agent is hydrogenated starch hydrolysate present in an amount between 25 to 35%.

3. The composition as defined in claim 2 wherein said fiber is present in an amount between 20 to 30%.

4. The composition as defined in claim 3 wherein said vegetable protein is vital wheat gluten and is present in an amount between 15 to 25%.

5. The composition as defined in claim 4 wherein said egg white is present in an amount between 5 to 15%.

6. The composition as defined in claim 3 wherein said fiber contains at least one fiber selected from the group consisting of cottonseed fiber, soy fiber, and sugar cane fiber.

7. The composition as defined in claim 3 wherein said fiber comprises soy fiber.

8. The composition as defined in claim 3 wherein said fiber is up to 350 microns in length.

9. The composition as defined in claim 8 wherein said fiber is between about 30 to 80 microns in length.

10. The composition as defined in claim 9 wherein said fiber is at least one fiber selected from the group consisting of soy fiber, cottonseed fiber, and sugar cane fiber.

11. The composition as defined in claim 1 wherein said fiber contains at least one fiber selected from the group consisting of cottonseed fiber, soy fiber, and sugar cane fiber.

12. The composition as defined in claim 1 wherein said fiber comprises soy fiber.

13. The composition as defined in claim 1 wherein said fiber has a length such that a product made with said composition has a mouth feel consistent with a mouth feel of a non-low carbohydrate grain product.

14. The composition as defined in claim 13 wherein said grain product is selected from the group consisting of breads, rolls, muffins, cakes, pastries, pies, pancakes, waffles, crepes, crackers, pastas, tortillas, and cereal.

15. The composition as defined in claim 1 wherein said fiber is between about 30 to 80 microns in length.

16. The composition as defined in claim 15 wherein said fiber is at least one fiber selected from the group consisting of soy fiber, cottonseed fiber, and sugar cane fiber.

17. The composition as defined in claim 1 further comprising one or more additives selected from the group consisting of: whey in an amount of less than 10% by weight, sodium bicarbonate in an amount less than 7% by weight, sodium aluminum phosphate in an amount less than 7% by weight, a dough conditioner in an amount less than 3% by weight, guar gum in an amount less than 2% by weight, carbo methyl cellulose in an amount less than 1%, and an artificial sweetener in an amount less than 1%.

18. The composition as defined in claim 17 wherein said artificial sweetener is N-[N-(3,3-dimethylbutyl)-L-α-aspartyl]-L-phenylalanine 1-methyl ester.

19. A bakery product made from the composition of claim 17 combined with an amount of water equal to 80% by weight of the weight of the composition.

20. The bakery product claimed in claim 19 wherein said composition and water are mixed at a low speed to avoid breaking down the wheat gluten, and baked for 25 to 30 minutes at 300 to 350 degrees Fahrenheit.

21. A food product having a reduced carbohydrate content, comprising:
a bulking agent which acts like a hard starch particle;
fibers; and
vegetable proteins,
wherein said fibers have a particle length of from about 20 microns to about 120 microns.

22. The food product according to claim 21, further comprising:
at least one egg white;
sweet dairy whey;
at least one leavening agent;
at least one thickening agent; and
at least one intense sweetener.

23. The food product according to claim 21, wherein said fibers are selected from the group consisting of soy fibers, cottonseed fibers, sugar cane fibers, and combinations thereof.

24. The food product according to claim 21, wherein said bulking agent comprises hydrogenated starch hydrolysate presented in an amount of from about 15-70%, said fibers are present in an amount from about 10-60%, and said vegetable proteins are present in an amount of from about 5-50%, wherein said amounts are based on the final volume of the food product.

25. The food product according to claim 21, wherein said food product is free of flour, sugar, salt, and oil.

26. A flour substitute comprising:
a bulking agent which acts like hard starch particles;
fibers; and
vegetable proteins,
wherein said fibers have a particle length of from about 20 microns to about 120 microns.

27. A sugar free food product comprising:
a hydrogenated starch hydrolysate;
fibers; and
vegetable protein,
wherein said fibers have a particle length of from about 20 microns to about 120 microns.

28. A starch-free product comprising:
a hydrogenated starch hydrolysate;
fibers; and
vegetable proteins,
wherein said fibers have a particle length of from about 20 microns to about 120 microns.

29. A sugar free and flour free food product comprising:
a hydrogenated starch hydrolysate;
fibers; and
vegetable protein,
wherein said fibers have a particle length of from about 20 microns to about 120 microns.

30. A flour free and sugar free bread product comprising:
a a bulking agent which acts like hard starch particles;
fibers;
vegetable proteins;
at least one egg white;
sweet dairy whey;
at least one leavening agent;
at least one thickening agent; and
at least one intense sweetener.
